(19) United States
(12) Patent Application Publication
(10) Pub. No.: US 2010/0084605 A1
(43) Pub. Date: Apr. 8, 2010

(54) PROCESS TO PREPARE CONCENTRATED ALKALI METAL HYPO-CHLORITE

(75) Inventors: Hendrikus Wilhelmus Bakkenes, Apeldoorn (NL); Mateo Jozef Jacques Mayer, Amersfoort (NL); Gerhard Fokko Remmers, Doetinchem (NL); Jan Visser, Arnhem (NL)

Correspondence Address: KENYON & KENYON LLP, ONE BROADWAY, NEW YORK, NY, 10004, US

(73) Assignee: AKZO NOBEL N.V., Arnhem (NL)

(21) Appl. No.: 12/517,788

(22) PCT Filed: Nov. 30, 2007
(86) PCT No.: PCT/EP07/63048

§ 371 Date: Jul. 28, 2009

Related U.S. Application Data
(60) Provisional application No. 60/873,900, filed on Dec. 8, 2006.

(30) Foreign Application Priority Data
Dec. 4, 2006 (EP) 06125325.8

(51) Int. Cl. C11D 3/395; B01J 8/18

(52) U.S. Cl. 252/187.26; 252/187.25; 422/139

(57) ABSTRACT

The present invention pertains to a process for preparing a concentrated alkali metal hypochlorite solution by reacting chlorine with an alkali metal hydroxide to form alkali metal hypochlorite, alkali metal chloride, and water, wherein one or more aqueous solutions comprising an alkali metal hydroxide and alkali metal hypochlorite are led in a swirling flow through one or more inlet pipes of a reaction vessel, wherein chlorine is injected into said reaction vessel at its top part and flows downwards through said one or more inlet pipes, and wherein the outflow openings of the one or more inlet pipes are arranged such that the solution leaving said outflow openings, being supersaturated with alkali metal chloride, is directed through a fluidized bed of said alkali metal chloride, while the flow direction is converted upwards through said fluidized bed.

The present invention relates to a process to prepare a concentrated alkali metal hypochlorite solution by reacting chlorine with an alkali metal hydroxide to form alkali metal hypochlorite and alkali metal chloride. The present invention preferably relates to a process to prepare a concentrated sodium hypochlorite solution.

Alkali metal hypochlorite solutions are industrially prepared by reaction of gaseous or liquid chlorine with a solution of the corresponding alkali metal hydroxide according to the general equation, with M being an alkali metal ion:

Cl₂+2MOH→MOCl+MCl+H₂O

Besides alkali metal hypochlorite, alkali metal chloride and water are formed. For sodium hypochlorite, for example, this reaction is typically carried out as a stationary process by continuously circulating a sodium hypochlorite product stream over an absorption tower or ejector and by dosing chlorine and sodium hydroxide to this circulating stream. After the reaction has taken place, the product is cooled, partially recycled, and fed to a product tank. In this manner aqueous sodium hypochlorite solutions are prepared which typically have an active chlorine content up to 170 g/l, with active chlorine expressing the total concentration of chlorine-based oxidants present in the solution and being the equivalent concentration or amount of Cl₂.

During the preparation of diluted alkali metal hypochlorite solutions, the produced alkali metal chloride will dissolve in the aqueous alkali metal hypochlorite solution. However, if higher concentrations of active chlorine are reached, the aqueous alkali metal hypochlorite solution will be saturated with alkali metal chloride. At even higher active chlorine concentrations the supersaturation level for alkali metal chloride will be exceeded and, as a consequence, the alkali metal chloride salt will precipitate.

A problem which often arises in processes wherein concentrated solutions of alkali metal hypochlorite are prepared is nucleation and crystal growth and eventually clogging of the chlorine inlet nozzles by solid alkali metal chloride deposits, especially if the process is operated over longer periods of time. In the past few decades, several methods and apparatuses have been developed which are all designed to prevent the equipment (e.g. heat exchangers, pipes) from becoming clogged.

JP 60-081003, for example, discloses a process to prevent a reactor being clogged by sodium chloride by wetting the wall surface of the reactor with a reaction liquid comprising sodium hydroxide.

JP 59-182204 teaches that chlorine gas should be introduced through a pipe, the opening of which should be situated above the reaction liquid surface in the reaction bath to prevent the adhesion of NaCl crystals on the top of the introduction tube, and by thoroughly stirring the reaction mixture.

JP 56-114807 discloses a method for producing a highly concentrated sodium hypochlorite aqueous solution, wherein deposition of sodium chloride crystals is prevented by introducing the chlorine through a pipe which is open in the flow direction of the reaction solution and further by adequately controlling the flow velocity of the reaction solution comprising sodium hydroxide and the introduction velocity of the chlorine gas. It is mentioned that if the flow velocity of the chlorine gas flowing in the chlorine introducing pipe is sufficient, gas-liquid mixing occurs in a zone a certain distance away from the tip portion of the chlorine pipe.

However, the uncontrolled precipitation of alkali metal chloride has the drawback that the salt crystallizes as fine particles. As a consequence, the alkali metal chloride particles are difficult to remove from the alkali metal hypochlorite solution and filtration does not prevent solid alkali metal chloride particles from remaining present in the mother liquor in significant quantities. Furthermore, uncontrolled alkali metal chloride precipitation leads to permanent damage to the processing equipment, mainly because of erosion corrosion. Erosion corrosion is the term used to denote destruction of material by the abrasive action of a moving corrosive fluid accelerated by the presence of solid particles carried in the fluid.

To deal with the just-mentioned problems associated with the continuous uncontrolled preparation of alkali metal chloride in concentrated alkali metal hypochlorite solutions, special processes and equipment have been developed over the years.

U.S. Pat. No. 4,780,303, for example, discloses a process for the continuous preparation of highly concentrated sodium hypochlorite solutions which controls the sodium chloride formed to prevent fouling of the heat exchanger equipment and which provides sodium chloride particles having a size in the order of 400 microns or greater to facilitate filtration and to reduce the mother liquor retention in the salt. The process comprises the two-stage reaction of chlorine with aqueous sodium hydroxide of from about 20-50 wt %, wherein the first stage of chlorination of the sodium hydroxide is carried out in an absorption column but without any precipitation of sodium chloride, and in the second stage of chlorination, the sodium hypochlorite solution leaving the absorption column is treated with chlorine in a crystallizer equipped with suitable agitation.

EP 0 527 083 discloses a highly concentrated alkali metal hypochlorite preparation process wherein in a receptacle consisting of a simple vertical column with a conical base surmounted by another vertical column of larger cross-section, the said columns being connected together by a conical frustum, chlorine and an alkali metal hydroxide solution are injected into the bottom part, while the resulting hypochlorite solution is taken from the top part. One part of this hypochlorite solution forms the output of the crystal-free concentrated hypochlorite solution, and the other part is cooled and recycled into the bottom part of the receptacle. The alkali metal chloride crystals are purged near the lower end of the bottom part of the receptacle, and the recycling and the injection of the reactants from the first stage are adjusted so that the alkali metal chloride crystals are fluidized in the bottom part of the receptacle. U.S. Pat. No. 3,287,233 discloses a similar process for the production of concentrated sodium hypochlorite solutions.

U.S. Pat. No. 4,428,918 describes a process for the preparation of concentrated aqueous solutions of alkali metal hypochlorite in which a suspension of crystals of alkali metal chloride in an aqueous solution of alkali metal hypochlorite is circulated from bottom to top in a tubular reaction chamber located in an enclosure, chlorine and an aqueous solution of alkali metal hydroxide are reacted in this suspension in the chamber, a fraction of the resulting suspension leaving the open upper part of the chamber, overflowing out of the enclosure, and being filtered to separate the crystals, while the remaining fraction of the suspension is kept in the enclosure, where it is recycled to the base of the reaction chamber.

In the processes according to these documents, chlorine is injected into the lower part of the reactor. However, it was found that injecting chlorine in this manner, i.e. as an upwardly directed gas stream, often has the drawback that there is a possibility of chlorine discharge to the head space which is difficult to keep under control.

It is an object of the present invention to provide an improved process for the production of concentrated alkali metal hypochlorite solutions wherein the scaling of alkali metal chloride, and as a result thereof, the risk of processing equipment being blocked is reduced, wherein the risk of chlorine discharge to the head space of the reactor is reduced, and wherein uncontrolled crystallization of alkali metal chloride that may lead to damaging of processing equipment because of erosion corrosion is reduced or even prevented.

It has surprisingly been found that the objects of the present invention are realized by contacting an aqueous solution comprising alkali metal hydroxide with chlorine in a special and controlled manner, followed by controlled crystallization of the produced alkali metal chloride in a fluidized bed. In more detail, the present invention relates to a process to prepare a concentrated alkali metal hypochlorite solution by reacting chlorine with an alkali metal hydroxide to form alkali metal hypochlorite, alkali metal chloride, and water, wherein one or more aqueous solutions comprising an alkali metal hydroxide and alkali metal hypochlorite are led in a swirling flow through one or more inlet pipes of a reaction vessel, wherein chlorine is injected into said reaction vessel at its top part and flows downwards through said one or more inlet pipes, and wherein the outflow openings of the one or more inlet pipes are arranged such that the solution leaving said openings, being supersaturated with alkali metal chloride, is directed through a fluidized bed of said alkali metal chloride while the flow direction is converted upwards through said fluidized bed.

By the term “swirling flow” as used throughout the description is meant that the aqueous solution(s) move(s) downwards through the inlet pipe(s) with a twisting or whirling motion and at least in part via the walls of said inlet pipe(s).

It was found that this process allows controlled build-up of the supersaturation level for alkali metal chloride due to good mixing of the alkali metal hydroxide and the chlorine. Together with separating reaction and crystallization zones, this leads to more controlled crystallization of alkali metal chloride. This way, there is considerably less risk of the inlet pipes becoming blocked by alkali metal chloride deposits, even if the process is operated for longer production times. Furthermore, alkali metal chloride crystals of satisfactory crystal size (typically greater than 1 mm) are obtained, as a result of which erosion corrosion problems are reduced considerably.

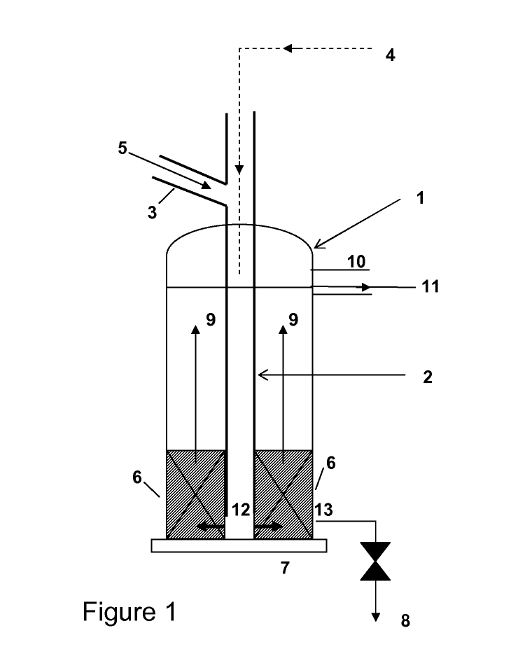

The present invention will now be explained in more detail with reference to a preferred embodiment as depicted in FIG. 1. This Figure is a schematic depiction of a preferred flow chart for the above-disclosed process. The reaction vessel (1) comprises an inlet pipe (2). Gaseous chlorine (4) is injected into the reaction vessel (1) through this inlet pipe (2) and it flows downwards through said pipe. An aqueous solution comprising alkali metal hydroxide and alkali metal hypochlorite (5) is introduced into the inlet pipe (2) in a swirling flow through a side inlet (3). The reaction mixture flows further downwards in a swirling flow through the inlet pipe (2), reaching the flat bottom (7) of the reaction vessel, as a result of which the flow direction is converted. Thus, the reaction mixture is directed through a fluidized bed of alkali metal chloride crystals (6), resulting in a clear and essentially crystal-free reaction mixture (9) with increased alkali metal hypochlorite concentration. The overflow (11) of the reaction vessel (1) is removed via an upper discharge opening (10). The reaction vessel (1) further comprises means for removal of the alkali metal chloride crystals (8) via a lower discharge opening (13).

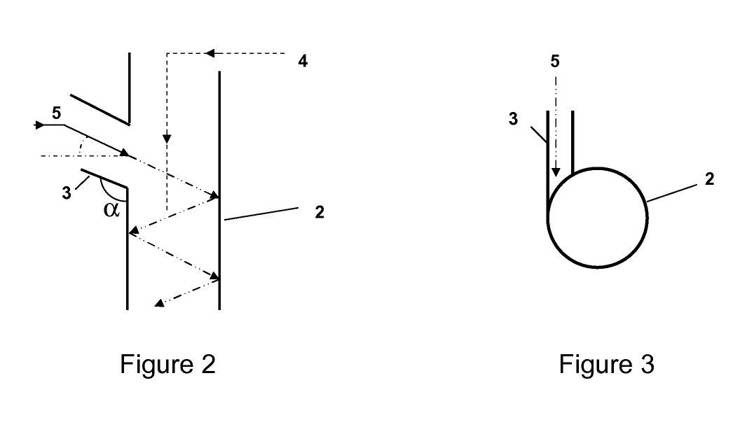

A sectional enlargement of the reaction vessel (1) with the inlet pipe (2) and the side inlet (3) is depicted in FIG. 2. Here it is shown in detail that the aqueous solution comprising alkali metal hydroxide and alkali metal hypochlorite (5) is led into the inlet pipe (2) in a swirling flow. Advantages of bringing chlorine and alkali metal hydroxide into contact with each other in this manner are that mixing of gas and liquid occurs in a controlled manner and that the wall of the inlet pipe (2) is constantly “washed”, so that possible alkali metal chloride scaling on this wall is prevented.

It is noted that a preferred manner of inducing the swirling flow is via a tangential inlet of the one or more aqueous solutions into the one or more inlet pipes (2). This embodiment is depicted in FIG. 3, which is a top view of the inlet pipe (2) and the side inlet (3). By the term “tangential inlet” as used throughout the description is meant that the side inlet (3) is connected to the inlet pipe (2) in such a manner that the inlet (3) is tangentially placed in respect of the inlet pipe (2). In other words, the longitudinal axis of the inlet (3) and the longitudinal axis of the inlet pipe (2) do not intersect.

Using a reaction vessel wherein the outflow opening (12) of the inlet pipe is situated above a flat bottom (7) is just one way of effectuating conversion of the flow direction of the reaction mixture, and the process according to the present invention is not limited thereto. The person skilled in the art can select other means for conversion of the flow direction on the basis of his common general knowledge. For example, this effect can also be obtained by using a reactor vessel with a conical lower part for removal of the alkali metal chloride crystals and one or more inlet pipes equipped with one or more deflectors. The latter embodiment is preferred. Typically, when an inlet pipe with a diameter of about 2.5 cm is used, the distance between the outflow opening (12) and the flat bottom (7) of the reaction vessel or a deflector plate is between about 2 and 5 cm, preferably about 3.5 cm.

The process according to the present invention is preferably carried out in a continuous manner. Hence, preferably, part of the overflow (11) leaving the reaction vessel (1) via the upper discharge opening (10) is recycled and re-entered into the reaction vessel, preferably through a side inlet (3). By the term “side inlet” as used throughout the description is meant an inlet connected to the inlet pipe (2) which is at an angle α of at least 20°, more preferably at least 30°, and even more preferably at least 35° to the inlet pipe (2), and at an angle of not more than 160°, more preferably not more than 150°, and even more preferably not more than 145° to the inlet pipe (2). The angle α is indicated in FIG. 2. Even more preferably, the inlet (3) is at an angle of between 45° and 150°. Most preferred is an inlet (3) which is at an angle of between 90° and 135° to the inlet pipe (2).

In the case of a batch process, the aqueous alkali metal hypochlorite solution led into the one or more inlet pipes (2), optionally via one or more side inlets (3) of the reaction vessel, preferably contains at least 180 g, more preferably at least 190 g, and most preferably at least 200 g of active chlorine per litre of said solution.

In the process according to the present invention, preferably an alkali metal hypochlorite solution is prepared which has an active chlorine content of at least 200 g, more preferably of at least 250 g, and most preferably of at least 280 g per litre of produced aqueous alkali metal hypochlorite solution. Preferably, an alkali metal hypochlorite solution is prepared which has an active chlorine content of at most 450 g, more preferably of at most 400 g, even more preferably of at most 380 g, and most preferably of at most 350 g per litre of produced aqueous alkali metal hypochlorite solution.

It is noted that the higher the desired concentration of alkali metal hypochlorite in the final product, the higher the active chlorine content in the aqueous alkali metal hypochlorite solution to be introduced into the inlet pipes (2) preferably is. It is also possible, and in fact preferred, to increase the concentration of the produced alkali metal hypochlorite solution by operating the process in a continuous mode, i.e. via a recycle of the overflow.

A combination of these two embodiments is also possible.

In both batch and continuous operation modes, the aqueous alkali metal hydroxide-containing solution fed into the one or more inlet pipes (2) of the reaction vessel preferably has a concentration of at least 5.5 mol of alkali metal hydroxide per litre, more preferably of at least 7 mol of alkali metal hydroxide per litre, and most preferably of at least 11 mol of alkali metal hydroxide per litre of said solution. Preferably, it does not comprise more than 13.5 mol of alkali metal hydroxide per litre, more preferably not more than 13 mol of alkali metal hydroxide per litre, and most preferably not more than 12.5 mol of alkali metal hydroxide per litre. With increasing alkali metal hydroxide concentrations, more concentrated alkali metal hypochlorite solutions can be prepared. However, as the skilled person will recognize, highly concentrated alkali metal hydroxide solutions have increasing viscosity and may eventually even solidify. Hence, working with highly concentrated alkali metal hypochlorite solutions often requires higher than ambient temperatures.

As described above, the aqueous solution comprising alkali metal hydroxide and the aqueous solution comprising alkali metal hypochlorite can be led via one or more, preferably tangential, inlets (3) into the one or more inlet pipes (2). It is possible to introduce the aqueous alkali metal hydroxide solution and the aqueous alkali metal hypochlorite solution into the one or more inlet pipes (2) via separate, preferably tangential, inlets (3). In that case, mixing of the two aqueous solutions takes place inside the inlet pipes (2), simultaneously with mixing with chlorine. However, preferably, the aqueous solution comprising alkali metal hydroxide and the aqueous solution comprising alkali metal hypochlorite are mixed prior to their entrance into the inlet pipes (2) because of better mixing.

The chlorine injected into the inlet pipes (2) is gaseous chlorine. It can be diluted with an inert gas as known in the art, in which case argon gas and nitrogen gas are the most preferred. However, since the crystallization step and the stability of the fluidized bed may be adversely affected by upwardly moving gas bubbles, the mere use of gaseous chlorine is preferred.

It is noted that the velocity of the aqueous alkali metal hydroxide solution and of the aqueous alkali metal hypochlorite solution through the one or more inlet pipes (2) is sufficiently high to keep the entire bed of alkali metal chloride crystals fluidized and to avoid the growth of a (partially) fixed bed of crystals. Typically, the velocity of the alkali metal hydroxide solution and of the alkali metal hypochlorite solution is therefore at least 0.10 m/s, more preferably at least 0.15 m/s, and most preferably at least 0.20 m/s.

The velocity of the chlorine gas preferably is not so high that a turbulent fluidized bed, with the risk of breakthrough of chlorine, is obtained. Typically, the velocity of the chlorine gas flowing downwards through the one or more inlet pipes (2) is therefore at least 0.02 m/s, preferably at least 0.03 m/s, and most preferably at least 0.05 m/s. Typically, the velocity of the chlorine gas is not higher than 1 m/s, preferably not higher than 0.5 m/s, and most preferably not higher than 0.1 m/s.

It is noted that the skilled person will be able to select the optimum velocities of the chlorine flow and the alkali metal hydroxide solution and the alkali metal hypochlorite solution by routine experimentation.

The temperature at which the process according to the present invention is preferably performed is at least 2° C., more preferably at least 6° C., even more preferably at least 12° C., and most preferably at least 15° C. Preferably, the temperature is not higher than 50° C., more preferably not higher than 40° C., even more preferably not higher than 30° C., and most preferably not higher than 20° C. The temperature is preferably controlled by means of a conventional heat exchanger. Furthermore, all inlet pipes (2) of the reaction vessel are preferably equipped with a cooling system.

The process according to the present invention is preferably performed with the internal pressure within the reaction vessel being at least atmospheric pressure. Preferably, the internal pressure within the reaction vessel is not higher than 15 bars. Most preferably, the process is performed with an internal pressure within the reactor vessel at or near atmospheric pressure.

The alkali metal can be any alkali metal, but preferably is potassium or sodium. Most preferably, it is sodium for the production of sodium hypochlorite, since this compound is widely used for its bleaching, disinfecting, and oxidizing properties. It is used for example in swimming pools to disinfect the water and to oxidize pollutants in the water, for disinfection of drinking and process water, for cleaning and disinfection of installations, and for waste water treatment.

The present invention also relates to an apparatus suitable for the process to prepare concentrated alkali metal hypochlorite solutions according to the present invention, optionally with an associated recycling system. The apparatus according to the present invention comprises a fluidized bed reaction vessel (1) having one or more inlet pipes (2) with their inlet(s) located at the top part of the reaction vessel and with their outer end(s) facing a flow-direction conversion element, leaving at least one outflow opening adjacent to the element and with said element directed towards a fluidized bed, said reaction vessel having one or more side inlets (3) tangential in respect of said inlet pipes (2), said reaction vessel further having an upper discharge opening (10), and said reaction vessel furthermore having a lower discharge opening (13). The one or more tangential inlets (3) are to be used for the addition of an aqueous solution comprising alkali metal hydroxide and an aqueous solution comprising alkali metal hypochlorite. The inlet pipes (2) are to be used for the introduction of chlorine gas. The discharge opening (10) is to be used for removing the overflow, i.e. the concentrated alkali metal hypochlorite solution.

The element which is present for effectuating a flow direction conversion of the solution that leaves the one or more inlet pipes (2) through at least one outflow opening (i.e. the flow-direction conversion element) is situated such that said solution is directed through a fluidized bed of alkali metal chloride crystals. Said element can be any means known in the art for conversion of the flow direction. Preferred is a flat element. More preferably, the flat element is a flat bottom (7) of the reaction vessel (1) situated under the discharge openings (12) of inlet pipes (2), one or more deflector plates adjacent to the outflow opening(s) of the inlet pipes (2), or a combination thereof. The lower discharge opening (13) is for draining the fluidized bed of alkali metal chloride crystals present in the bottom part of the reaction vessel (1).

A preferred example of a suitable configuration of a reactor for carrying out the process according to the present invention is shown in FIG. 1. Preferably, the upper discharge opening (10) is connected, via a conduit, to one or more inlets (3), preferably via a product accumulator (not shown) and optionally via a heat exchanger (not shown), in order to perform the process in a continuous manner. As described above, the inlet pipe (2) has at least one outflow opening. This outflow opening can be a hole or gap at the side of the inlet pipe (2), adjacent to the flat element. Preferably, however, the outflow opening is the open underside of the inlet pipe (2), as depicted in FIG. 1.

The process according to the present invention is further illustrated by the following examples.

### EXAMPLE 1

An experimental set-up as indicated in FIG. 1 was built up out of standard glass equipment (ex QVF, Germany) connected via Teflon tubing (Entegris Fluoroline® 4200 PFA Tubing). The chlorine inlet pipe was equipped with a tangential inlet (45° axial with the inlet pipe, i.e. with a being 135°) for supply of the circulating aqueous solution of sodium hydroxide and sodium hypochlorite. Before the experiment was performed, the experimental set-up was loaded with 20 litres of de-mineralized water and approximately 25 kg of Sanal-P salt (ex Akzo Nobel, Hengelo, The Netherlands) as a precursor for the fluid bed. The experimental set up was operated in continuous feed-and-bleed operation mode at a re-circulation flow rate of approximately 250 litres per hour. During the experiment the amount of Cl₂-gas (ex Hoekloos, the Netherlands) was controlled at 0.5-1 litre per minute (the pressure was 3 bars). The amount of 50% NaOH (ex Chemproha ChemicalPartner, the Netherlands) added was controlled by keeping the resulting redox-couple in the range between 520 and 550 mV (measured with a Yokogawa thermoelectric couple type SR20-AC22 and XD67737822). The resulting pH of the re-circulating flow was in the range of 12-14. After 48 hours, a concentrated crystal-free sodium hypochlorite solution was obtained with a density of 1333 g/l, representing a concentration of approximately 315 g of active chlorine per litre or 330 g of NaOCl per litre. During the experiment sodium chloride crystallized out and as a result the fluid bed grew. In order to keep up stable process conditions the salt was discontinuously drained.

The process was continued for about 72 hours without any scaling and/or blocking problems, indicating that the reduction of the supersaturation level of the sodium chloride indeed takes place in the crystallization zone, i.e. in the fluid bed.

### EXAMPLE 2

Another experiment was performed with the experimental set-up as described in Example 1.

Now, before the experiment the experimental set-up was loaded with a 20-litre solution of 170 g. active Cl₂/l (ex Membrane Electrolysis pilot plant, Akzo Nobel, Arnhem, The Netherlands) and approximately 25 kg of Sanal-P salt (ex Akzo Nobel, Hengelo, The Netherlands) as a precursor for the fluid bed.

The experimental set-up was again operated in continuous feed-and-bleed operation mode at a re-circulation flow rate of approximately 250 l/h. During the experiment the amount of Cl₂-gas (ex Hoekloos, the Netherlands) was controlled at 0.5-1 litre per minute (the pressure was 3 bars). The amount of 50% NaOH (ex Chemproha ChemicalPartner, the Netherlands) added was controlled by keeping the resulting redox-couple in the range of between 520 and 550 mV (measured with a Yokogawa thermoelectric couple type SR20-AC22 and XD67737822). The resulting pH of the re-circulating flow was in the range of 12-14. After 80 hours, a concentrated crystal-free sodium hypochlorite solution was obtained with a density of 1333 g/1, representing a concentration of approximately 315 g of active chlorine per litre or 330 g of NaOCl per litre.

During the experiment sodium chloride crystallized out and as a result the fluid bed grew. In order to keep up stable process conditions the salt was discontinuously drained.

The process was continued for about 100 hours without any scaling and/or blocking problems.

### COMPARATIVE EXAMPLE A

Another experiment was performed with the experimental set-up as described in Example 1. However, the fluid bed of approximately 25 kg of Sanal-P was replaced by a fixed bed of the same quantity of compacted sodium chloride grains of 1-3 mm (Broxo 1-3, ex Akzo Nobel, Hengelo, The Netherlands). Other process conditions were equivalent to those described in Examples 1 and 2. Initially, this resulted in a clear, crystal-free concentrated sodium hypochlorite solution. After 3-4 hours an increasing reduction of the product flow through the bed of sodium chloride crystals was observed, probably because of crystal bridges growing between the compacted salt grains.

In this experiment also no scaling problems were observed. However, although it was found that a clear, crystal-free product can be obtained in this manner, a fluid bed is needed to obtain economically acceptable production times.

1. A process to prepare a concentrated alkali metal hypochlorite solution, the process comprising: reacting chlorine with an alkali metal hydroxide to form an alkali metal hypochlorite, an alkali metal chloride, and water, wherein one or more aqueous solutions comprising the alkali metal hydroxide and the alkali metal hypochlorite are led in a swirling flow through one or more inlet pipes of a reaction vessel, wherein chlorine is injected into said reaction vessel at its top part and flows downwards through said one or more inlet pipes, and wherein the outflow openings of the one or more inlet pipes are arranged such that the solution leaving said outflow openings, being supersaturated with the alkali metal chloride, is directed through a fluidized bed of said alkali metal chloride, while the flow direction is converted upwards through said fluidized bed.

2. The process according to claim 1 wherein the swirling flow is induced by means of a tangential inlet of the one or more aqueous solutions into the one or more inlet pipes.

3. The process according to claim 1 wherein the aqueous alkali metal hypochlorite solution which is led through the one or more inlet pipes comprises at least 180 g of active chlorine per liter of said aqueous solution.

4. The process according to claim 3 wherein the concentrated alkali metal hypochlorite solution has a strength of from 200-450 grams, of active chlorine per liter litre of said aqueous solution.

5. The process according to claim 1 wherein the internal pressure within the reaction vessel is at or near atmospheric pressure.

6. The process according to claim 1 wherein the reaction of chlorine and the alkali metal hydroxide is performed at a temperature of between 2 and 50° C.

7. The process according to claim 1 wherein the one or more inlet pipes of the reaction vessel are equipped with a cooling system.

8. The process according to claim 1 wherein the alkali metal is sodium and wherein concentrated sodium hypochlorite is produced.

9. The process according to claim 2 wherein a part of an overflow of the reaction vessel is recycled to the tangential inlet.

10. An apparatus comprising a fluidized bed reaction vessel comprising:
one or more inlet pipes with their inlet(s) located at the top part of the reaction vessel and with their outer end(s) facing a flow-direction conversion element, leaving at least one outflow opening adjacent to the conversion element and with said element directed towards a fluidized bed,
one or more side inlets tangential in respect of said one or more inlet pipes
an upper discharge opening, and
a lower discharge opening.

11. The apparatus according to claim 10 wherein the upper discharge opening is connected, via a conduit, to the one or more side inlets.

12. The apparatus according to claim 10 wherein the flow-direction conversion element is a flat bottom of the reaction vessel, a deflector plate, or a combination thereof.

13. The process according to claim 3 wherein the concentrated alkali metal hypochlorite solution has a strength of from 280-400 grams, of active chlorine per liter of said aqueous solution.

14. The process according to claim 1 wherein the reaction of chlorine and the alkali metal hydroxide is performed at a temperature of between 15 and 20° C.

15. The process according to claim 3 wherein the internal pressure within the reaction vessel is at or near atmospheric pressure.

16. The process according to claim 4 wherein the internal pressure within the reaction vessel is at or near atmospheric pressure.

17. The process according to claim 4 wherein the reaction of chlorine and the alkali metal hydroxide is performed at a temperature of between 2 and 50° C.

18. The process according to claim 5 wherein the reaction of chlorine and the alkali metal hydroxide is performed at a temperature of between 2 and 50° C.

19. The process according to claim 4 wherein the alkali metal is sodium and wherein concentrated sodium hypochlorite is produced.

20. The process according to claim 6 wherein the alkali metal is sodium and wherein concentrated sodium hypochlorite is produced.
